(19) United States
(12) Patent Application Publication
(10) Pub. No.: US 2006/0232094 A1
(43) Pub. Date: Oct. 19, 2006

(54) Transparent light shade

(76) Inventor: Peter Graf, Adernach (DE)

Correspondence Address: Joseph A Calvaruso;Chadbourne & Parke, 30 Rockefeller Plaza, New York, NY, 10112, US

(21) Appl. No.: 10/553,219

(22) PCT Filed: Apr. 16, 2004
(86) PCT No.: PCT/EP04/04057

§ 371 Date: Oct. 14, 2005

(30) Foreign Application Priority Data
Apr. 17, 2003 (DE) 103 17 695.0
Jan. 22, 2004 (DE) 10 2004 003 184.3

(51) Int. Cl. B60J 3/00

(52) U.S. Cl. 296/97.1

(57) ABSTRACT

The invention relates to a device for preventing blinding effects on vehicle or machine drivers in flexible positions which, however, results in a significant restriction in the field of vision and/or for use as a medium for presenting visual information. In order to correct for a restriction in the field of vision and to use the shade as a medium for presenting visual information, the light/sun shade is made of transparent materials and comprises an integrated information system.

The invention concerns a device for the avoidance, in flexible positions, of the blinding effect on a motor vehicle or machine operator, with insignificant restriction of the field of vision and/or for utilization as a medium of visual information display.

There are known devices for the avoidance of the blinding effect on a motor vehicle or machine operator, in flexible positions. The drawback of such known light or sunscreens for motor vehicles or machines lies in the fact that they are not transparent, thereby restricting the field of vision. They do not afford the possibility of a visual display of information. A further drawback is that no provision is made for a change of position or extension and shifting, if not to a limited extent, so that an appropriate focusing on the source of the glare is not feasible.

True, light or sun screens in motor vehicles or other machines do fulfill their antidazzle function, but they block the view onto the roadway or, for example, the job site, production or workshop (crane, dredger, stacker), though this is precisely of overriding importance to the operator of the motor vehicle. The protective screen is aimed at the frontal blinding effect and is accordingly not flexibly adjustable. This, however, does not match the everyday practical situation, since the blinding effect does generate at different angles as well. A further drawback lies in the fact that visual information displays, for example for navigation, broadcast advertisers or internet, are placed in such a way that the motorist needs to divert his gaze away from the roadway or the jobsite.

The task of the invention is to enhance the device of the previously described nature in such a way as to achieve good light or sunshine protection, without materially restricting the view of the highway traffic or jobsite, thereby in particular avoiding the risk of an accident by reason of blocked vision.

Another task of the invention is to outfit the device in such a way as to afford similar light and sunshine protection in the open space between the driver and his front-seat passenger.

A further task of the invention is to bring required information into the field of vision of the vehicle or machine operator without distracting his attention away from the roadway or the jobsite.

The task of the invention is solved by making the sunscreen out of transparent materials. By making use of such transparent materials as glass, acrylics, plastics or other transparent media, the unobstructed view for example of the highway traffic or jobsite is enhanced. The use of appropriate stained glasses or the like achieves good light or sunshine protection and the risk of accidents is diminished in that it is possible to keep highway traffic or the jobsites under better surveillance, since the field of vision is not restricted.

The further task of the invention is solved in that the device is extractable. This has the advantage that between the screens on the side of the driver and on the side of the passenger, light and sunshine protection is also afforded or else, the other angles may be adjusted to match the source of dazzle. What this accomplishes is that both grownups and young vehicle occupants may make use of the device, without blocking or restricting vision.

The further task of the invention is solved in that the sunscreen is made of transparent materials and possesses an integrated information system.

Technical media, such as navigation and/or other information may be displayed by the invented device. Further information, such as traffic jam messages and the like may be transmitted onto the screen. In this manner, information may be passed to the operator of the vehicle or the machine over one range of vision, without the need for the vehicle or machine operator to distract his attention from the roadway or jobsite.

The invention thus makes possible an advantageous combination of a variety of useful functions.

Additional advantageous embodiments of the invention are specified in the subordinate claims.

The displacement of the screen is preferably accomplished by the provision of a casing on the upper side of the screen. The supporting linkages of the screen run within such casing. As the result, the screen may be displaced from the driver's side to the right. On the passenger's side, this is accomplished in the opposite direction.

Inasmuch as the screen is secured onto the top of the vehicle or the body pillar of the vehicle by a ball bearing, the screen may be tilted in the direction of the driver's or the passenger's door, so as to avoid here, too, the blinding effect in the event of lateral incidence of light. A retainer is mounted on the upper portion of the casing to hold the screen in its position of rest.

Preferably, transparent all-round cushioning further contributes to the prevention of an accident.

A retrofitted installation of the light or sun screen is also feasible.

In one preferred embodiment, the device features at least one display, that is, a visual information message. The display may be utilized to reproduce such information as for example of a navigation system or a traffic jam warning. Alternatively or cumulatively, the display may also feature actual parameters, as for example driving speed, engine rpm's, external temperature or the like. This makes it possible to display appropriate information to the driver within a field of vision that he can observe without diverting his gaze from the roadway.

Preferably, the device may be directed at the source of the blinding light so that with the device it is possible to suppress flexibly the blinding effect, for example of a setting sun or high-beam lights of oncoming traffic. Thanks to the transparency of the screen, unrestricted vision is feasible in all conceivable situations.

By the application and/or integration of filtering materials, the device can confine or fully suppress the blinding effect. The term filtering materials is understood to mean such materials as are capable of filtering out certain components of the light, as is true for example of stained glass plates.

Preferably the device is exchangeable and/or composed of especially exchangeable individual components, to afford the greatest possible flexibility and permit, in particular, even re-fitting or retrofitting.

In a preferred embodiment, the entire device and/or its edges and/or corners allow reversible reshaping, to afford the greatest possible security against injury, should the vehicle occupants impact against the device in an accident.

The device preferably features at least one sensor, in particular a photocell, whereby the intensity of the irradiating light may be measured. Thus, by determining the intensity of the irradiating light, a measurement is secured of the potential blinding effect, based on which the filtering action of the screen may be matched to the incident light.

In a particularly preferred embodiment, the device features an electro-metallic layer, in particular an electro-metallic foil. Electro-metallic layers have the property, based on an electric impulse, to change the color and/or optical properties.

Preferably, the electro-metallic layer is an electro-metallic polymer foil, which may be directly or indirectly applied onto the transparent material. By applying a voltage of, for example, 1.5 Volt onto this electro-metallic foil, a mirror-image effect is achieved, making it possible to switch the condition of the electro-metallic foil.

This accomplishes a switchable mirror image integrated in the device, that is to say, that it is possible to switch at will in particular the lack of transparency and/or the transparency of the screen and the mirror image effect of the screen.

Preferably, each electro-metallic layer is arranged between two layers of the transparent material, so that by such stratification the greatest possible protection is afforded against damage to the electro-metallic layer and a long-lasting functional safety of the electro-metallic layer.

Preferably, a voltage may be applied to each electro-metallic layer, which may be regulated in particular depending on the incidence of light, making it possible for example on the basis of the signal emitted by one or more sensors to switch on one or more electro-metallic layers, thereby adjusting the optic properties of the device to the particular conditions of the light.

In a preferred embodiment the device functions as a projecting surface and/or display, that is, visual information display for the optical reproduction of areas located to the side and/or the back of the vehicle, observable for example with the aid of a camera system. This makes it possible to avoid the so-called blind spots, particularly in large and poor-visibility vehicles, such as lorries or construction trucks, thereby reducing the hazard of accidents.

Exemplified embodiments of the invention are illustrated in the drawings and described in greater detail hereunder, as follows:

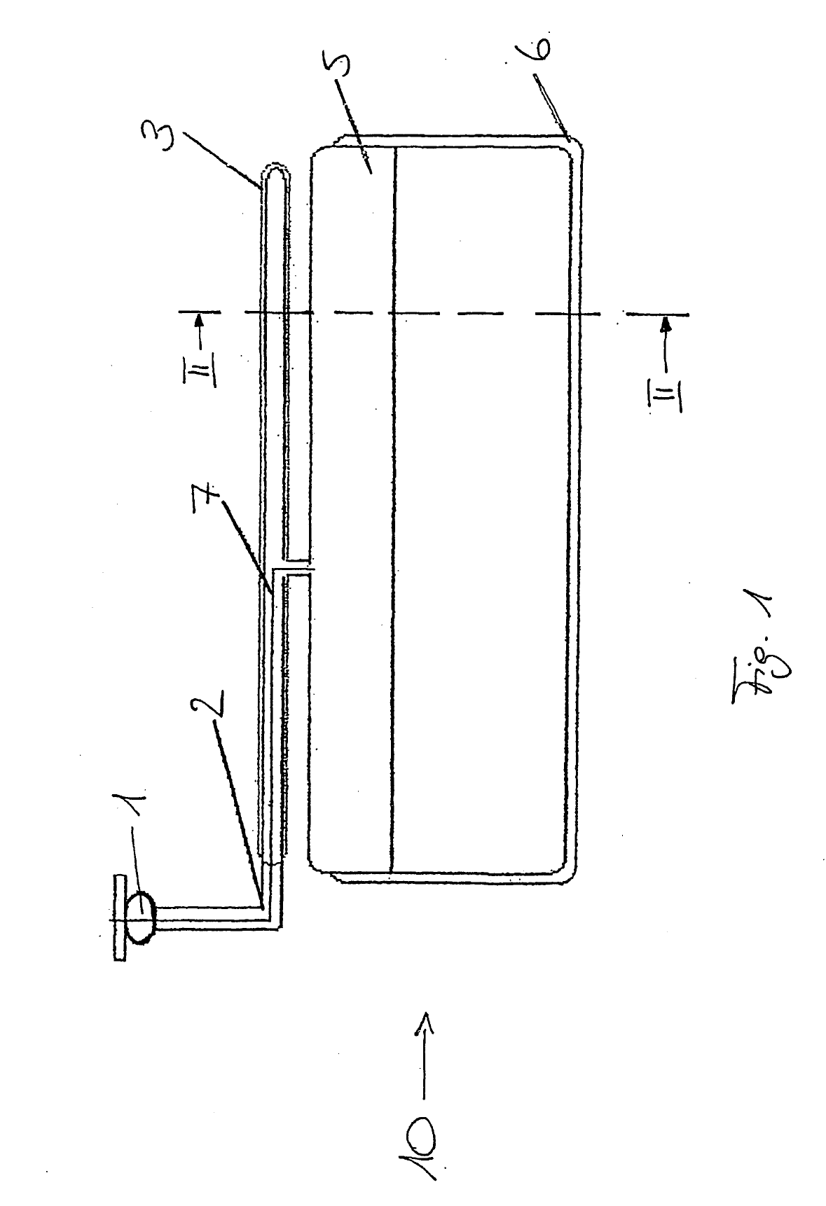

FIG. 1. Frontal view of an embodiment of the device according to the invention;

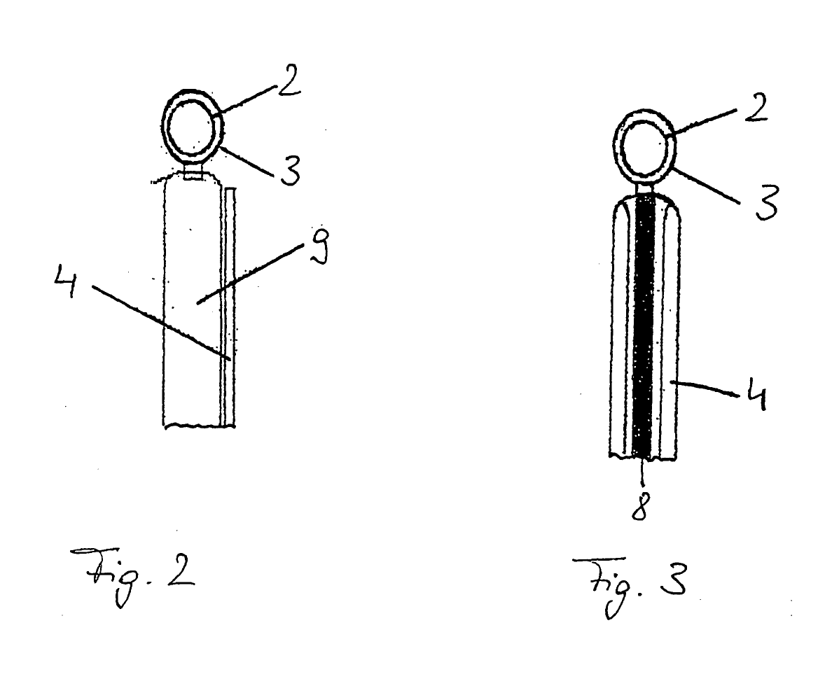

FIG. 2: A cross-section II-II according to FIG. 1;

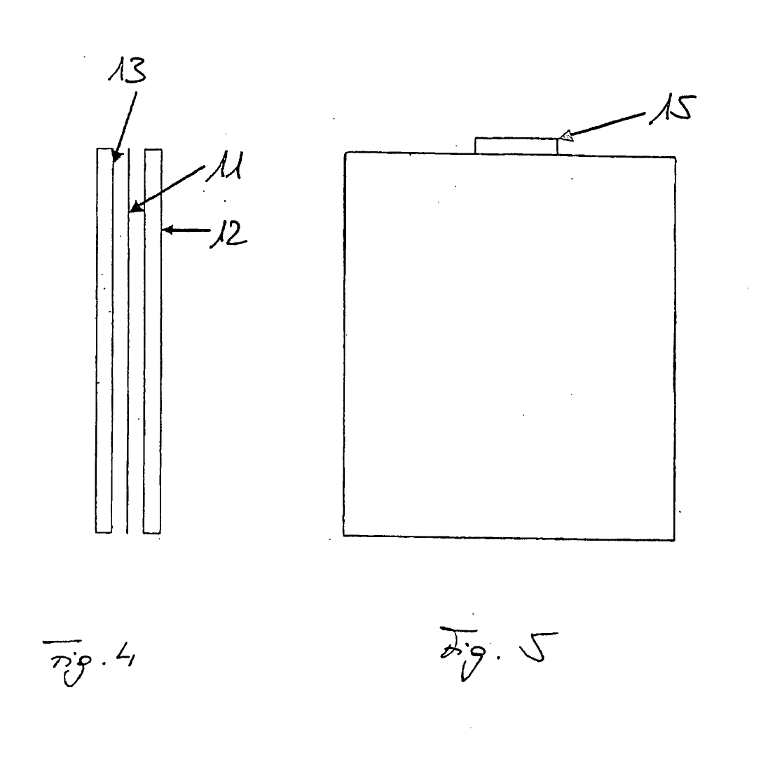

FIG. 3: Cross-section of another embodiment of the invented device;

FIG. 4: A schematic arrangement of an electro-metallic layer between two layers of transparent material;

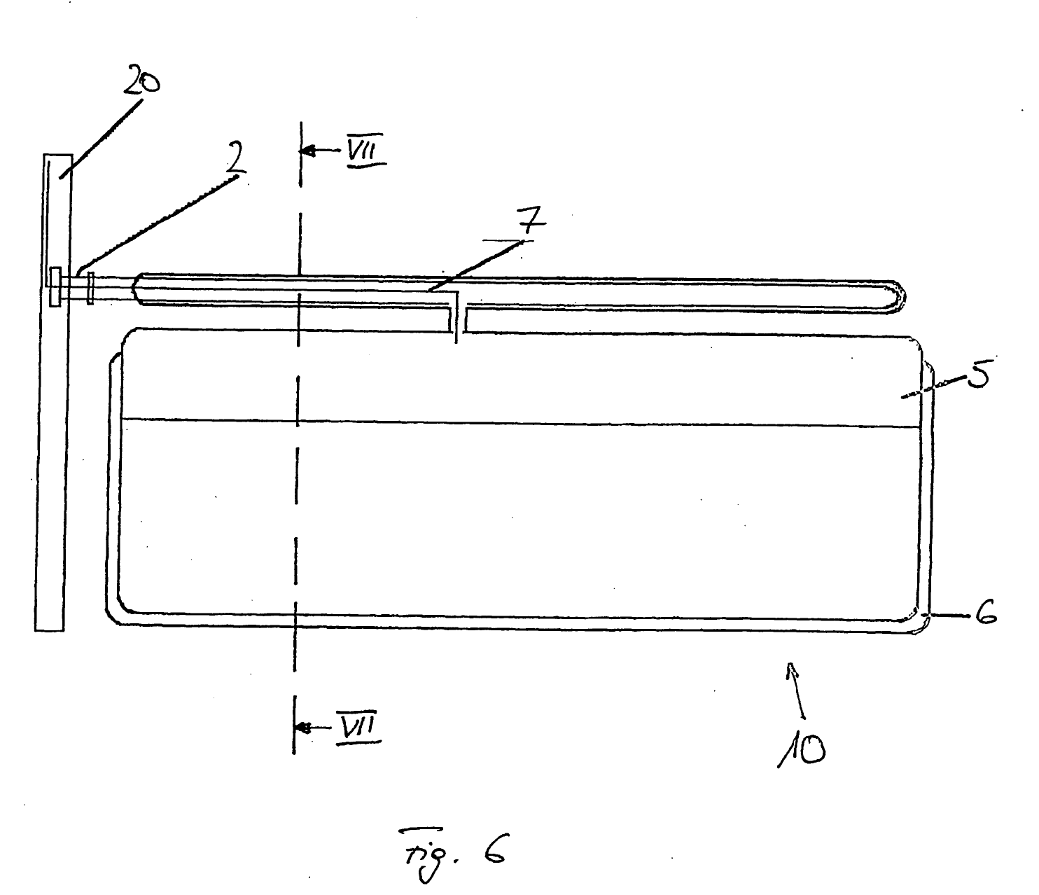

FIG. 5: Frontal view of the arrangement according to FIG. 4;

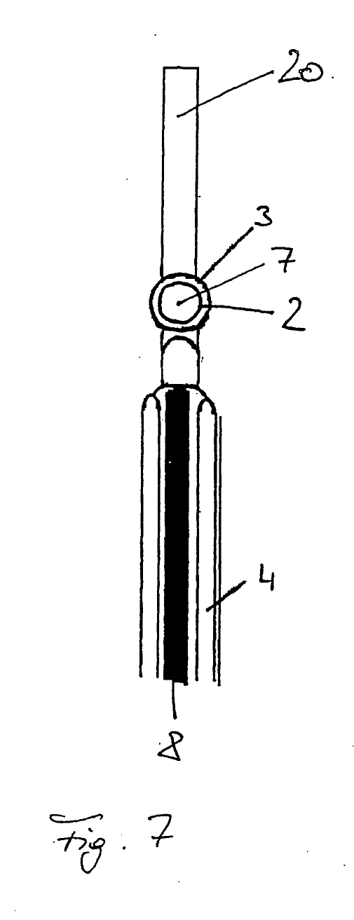

FIG. 6: Frontal view of another embodiment of the invented device;

FIG. 7: Cross-section VII-VII according to FIG. 6.

FIG. 1 shows a frontal view of an embodiment of the invented device, that is, a transparent light or sun screen. To make the screen 10 movable, use is made of a linkage 2, which is mounted for example on the roof of the vehicle with the aid of a rotary head 1 and a suitable retainer.

To permit shifting the screen 10, a second casing 3 (rabbit's ear) is mounted slidably on the linkage 2. The clearance between casing 3 and linkage 2 is chosen in such a way as to make the screen 10 easily slidable along the linkage 2. The linkage 2 as well as the casing 3 are secured to the transparent screen 10 with clips or other types of attachment.

The screen 10 itself consists of glass, plastics, acrylics or other transparent materials. The chosen material may be coated to deflect light. As indicated in FIG. 2, the screen 10 features a special filtering coat 4.

An information field 5 is integrated within an area on the upper border of screen 10. This field 5 may be employed to display highway traffic or other information, as for example navigation aid messages. The corresponding data and supply cables 7 are fed to the screen 10 with the information field 5 through the linkages 2 and casings 3. To this end, field 5 features an LCD display or the like.

On grounds of safety, provision is made for transparent all-round cushioning 6 to act flexibly and absorb impact on vehicle occupants. Nevertheless, the same may be dispensed with, depending on the injury-protective material of the light or sunshine screen, that is to say, the flexibility of the material of screen 10.

The build-up of the light or sunshine screen consists of multiple layers, as illustrated in FIGS. 2 and 3.

FIG. 2 is a schematic illustration of the structure of the light or sun screen 10. A layer 9 of the light or sun screen 10 is a transparent (see-through) protective coat consisting of acrylic, plastics, glass or similar materials. Another coating 4 is a transparent layer used for the display of data. This layer may display all kinds of information, as for example system information on the vehicle, navigation, traffic jams, pictorial information, speed warnings, TV, video etc. The display of the information may be limited to a circumscribed area of the light and sun screen 10, however, the information may also be displayed over the entire surface of the light and sun screen 10.

FIG. 3 is a cross-sectional representation similar to FIG. 2, whereby in this exemplified embodiment of the invented device the transparent material 8 of the screen 10 is stained, so as to achieve better filtration of the incident and potentially blinding irradiation of light.

Another layer may be designed on the one hand as a safety layer or alternatively as a glare protection. A further criterion is the transparency (translucency) of the layer. By the application of substantially non-translucent materials, as by metal vaporization or other processes, it is possible to ensure a one-sided glare and/or light protection. The individual layers may be combined into a single unit by welding, gluing or other techniques. It is also conceivable that the individual layers of the light and sun screen may be produced as single layers, so that these layers are exchangeable. With suitable materials, the light or sun screen may also be constructed in such a way that the light or sun screen per se is soft and/or flexible. By making the light or sun screen appropriately workable along its edges, it is possible to enhance its accident safety.

FIG. 4 shows the schematic layout of an electro-metallic layer between two layers 12 and 13 of transparent material. The electro-metallic layer is an electro-metallic foil 11, capable of changing its optical properties by the application of an electric voltage. The electro-metallic foil 11 is protected against damage by the two layers 12, 13 of transparent material upon which the electro-metallic foil 11 may be directly applied. To apply electric voltage onto the electro-metallic foil 11, use is made of the supply cables 7 (FIG. 1) or other conduits.

FIG. 5 is a frontal view of the schematic layout illustrated in FIG. 4. Provision is made for a control unit 15 to switch on and thereby affect the optical properties of the electro-metallic foil 11. The control unit 15 may be remote-controlled.

Provision is preferably made for a light-sensitive sensor, in particular a photocell. This sensor may be integrated within the control unit 15. Depending on the intensity of the light radiations, the signal generated by the sensor may be utilized to switch on the electro-metallic foil 11, in order to adapt optimally and automatically the optical properties of the device as a whole to the prevailing light conditions. To this end, provision may also be made for multiple layers of electro-metallic foil, each of them individually switchable.

Another layer not illustrated here may generate a mirror-image effect on an electro-metallic basis. Such a mirror-image effect may be switched on or off periodically at will. The mirror-image effect may be limited to a circumscribed area of the light and sun screen and/or extended to the entire surface of the light and sun screen.

Alternatively to securing in on the roof of the vehicle, the device may be mounted for example on the frame as shown in FIG. 6, thereby making for a more flexible individualized placement of the screen 10, which may be adjusted by the driver of the vehicle. The code numbers used in FIG. 6 represent the same characteristics previously used in the embodiments exemplified in FIGS. 4 to 6. Screen 10 is secured indirectly to linkage 2 by way of a sliding sleeve 3. The linkage 2 rotates height-adjustably on the mounting rod 20, which may be for example secured onto a pillar of the car frame. The screen slides over the link between the sleeve 3 and the linkage 2. Integrated into the mounting rod 20 and the linkage 2 is a data and supply cable 7 feeding the information field 5, integrated in the upper segment of the screen 10.

To reduce the risk of injury to the occupants in case of impact against the screen 10, the latter features all-round cushioning 6.

Thanks to the infinitely variable adjustment of the linkage 2 with the sleeve 3 as well as the bearing I of the light and sun screen 10, it is possible to screen off optimally the source of the glare. To this end, the screen 10 may be rotated, tilted, clipped over and height or laterally adjusted in all directions.

FIG. 7 is the VII-VII cross-section according to FIG. 6, comparable to the illustration in FIG. 3. Again, the same code references designate the same features. The figure illustrates a cross-section not unlike FIG. 3, whereby in this exemplified embodiment of the invented device the transparent material 8 of the screen 10 is tinted in order to achieve better filtration of the incident and potentially blinding light irradiation. A layer 4 serves as display for the visual reproduction of information.

Alternatively, the light and sun screen may be mounted automatically movable, for example on the roof of the vehicle. By way of an electric impulse or remote radio control the light or sun screen may be activated so that the light or sun screen travels or clicks over automatically into the range of vision of the car driver and/or his passenger. Alternatively to the mounting according to the exemplified embodiments, the screen may be outfitted so that without the added sleeve, the screen can be connected directly with, movable and tiltable on the supporting linkage.

1.-17. (canceled)

18. A light visor for use by an occupant of a machine comprising:
a transparent sun screen mounted to the machine such that it can be positioned between the operator and a light source; and
wherein the transparent sun screen comprises an electro-metallic layer that can be optionally transitioned between transparent and translucent states.

19. The light visor of claim 1 wherein the electro-metallic layer is an electro-metallic polymer foil.

20. The light visor of claim 1 wherein the transparent sun screen comprises a transparent layer onto which the electro-metallic layer is applied.

21. The light visor of claim 1 wherein the transparent sun screen comprises at least two transparent layers with the electro-metallic layer sandwiched between them.

22. The light visor of claim 1 wherein a voltage is applied to the electro-metallic layer and wherein the voltage varies based on the amount of light incident on the light visor.

23. The light visor of claim 1 wherein the electro-metallic layer can be optionally transitioned to a mirrored appearance.

24. The light visor of claim 1 wherein the sun screen displays pictorial information.

25. The light visor of claim 1 wherein the transparent sun screen further comprises an integrated information system.

26. The light visor of claim 1 wherein the sun screen further comprises at least one visual information display.

27. The light visor of claim 1 wherein the sun screen is flexibly mounted to the machine such that it may be movably positioned between the light source and the occupant.

28. The light visor of claim 1 wherein the sun screen is used as a medium for displaying varying visual information.

29. The light visor of claim 1 wherein the sun screen further comprises light filtering materials.

30. The light visor of claim 1 wherein the sun screen is releasably attached.

31. The light visor of claim 1 wherein the sun screen is releasably attached as a singe component.

32. The light visor of claim 1 wherein the light visor is reversibly compressible.

33. The light visor of claim 1 wherein the sun screen is reversibly compressible on one or more of its edges.

34. The light visor of claim 1 wherein the sun screen is reversibly compressible on one or more of its corners.

35. The light visor of claim 1 further comprising a light sensor.
